(19) United States
(12) Patent Application Publication
(10) Pub. No.: US 2008/0219439 A1
(43) Pub. Date: Sep. 11, 2008

(54) Image processing apparatus, encryption communications device, encryption communications system, and computer readable medium

(75) Inventor: Nobukazu Miyoshi, Kanagawa (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/984,974

(22) Filed: Nov. 26, 2007

(30) Foreign Application Priority Data
Mar. 8, 2007 (JP) 2007-058293

(51) Int. Cl. H04L 9/00; G06F 3/12

(52) U.S. Cl. 380/44; 358/1.1

(57) ABSTRACT

An image processing apparatus includes: a first value generation unit that generates a first value changing in time sequence; a second value generation unit that generates a second value changing in time sequence identical with the time sequence of the first value; a synchronization unit that synchronizes the first and the second value generation unit; a value output unit that causes the first and second value generation unit to simultaneously output the first and second values; a first key generation unit that generates a first key in accordance with the output first value output; an encryption unit that encrypts information in accordance with the generated first key; a second key generation unit that generates a second key in accordance with the output second value; and a decryption unit that decrypts the information encrypted by the encryption unit, in accordance with the generated second key.

### CROSS-REFERENCE TO RELATED APPLICATIONS

This application is based on and claims priority under 35 U.S.C. 119 from Japanese Patent Application No. 2007-058293 filed Mar. 8, 2007.

### BACKGROUND

### 1. Technical Field

The present invention relates to an image processing apparatus, an encryption communications device, an encryption communications system, and a computer readable medium.

### SUMMARY

According to an aspect of the present invention, an image processing apparatus including: a first value generation unit that generates a value changing in time sequence; a second value generation unit that generates a value changing in time sequence identical with that of the value changing in time sequence; a synchronization unit that synchronizes the first value generation unit and the second value generation unit; a value output unit that causes the first value generation unit and the second value generation unit to simultaneously output values; a first key generation unit that generates a first key in accordance with the value output by the first value generation unit; an encryption unit that encrypts information in accordance with the first key generated by the first key generation unit; a second key generation unit that generates a second key in accordance with the value output by the second value generation unit; and a decryption unit that decrypts the information encrypted by the encryption unit, in accordance with the second key generated by the second key generation unit.

### BRIEF DESCRIPTION OF THE DRAWINGS

Exemplary embodiment of the present invention will be described in detail based on the following figures, wherein:

FIG. 1 is a general block diagram of a multifunction machine which is an example image processing apparatus;

FIG. 2A is a general block diagram of encryption and decryption circuits of a first embodiment, FIG. 2B is a detailed block diagram of the circuits, and FIG. 2C is a detailed view of a random number generator;

FIG. 3A is a timing chart of random number initialization and

FIG. 3B is a general view of block encryption;

FIG. 4 is an example timing chart of a program defined in claim 19;

FIG. 5A is a general block diagram of encryption and decryption circuits of a modification of the first embodiment and FIG. 5B is a detailed block diagram of the circuits;

FIG. 6A is a general block diagram of encryption and decryption circuits of a second embodiment, and FIGS. 6B and 6C are detailed block diagrams of the circuits;

FIG. 7 is a conceptual rendering showing a storage area of an HDD;

FIG. 8 is an example timing chart of a program defined in claim 20;

FIG. 9 is a conceptual rendering showing a block encryption mode;

FIG. 10A is a general block diagram of an encryption communications system, and FIGS. 10B and 10C are detailed block diagrams of the system;

FIG. 11 is a flowchart of key generation performed by a key generation circuit;

FIG. 12 is a flowchart of encryption performed by an encryption circuit; and

FIG. 13A is a general block diagram of encryption and decryption circuits of a third embodiment, and FIGS. 13B and 13C are detailed block diagrams of the circuits.

### DETAILED DESCRIPTION

### First Embodiment

In a first embodiment, an image processing apparatus equipped with a common key technique defined in claim 1 will be described.

### (Structure of the Image Processing Apparatus of the First Embodiment)

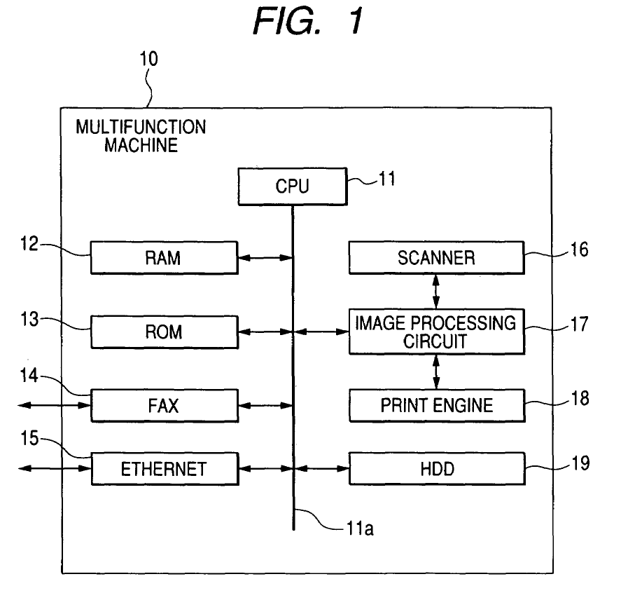

FIG. 1 is a general block diagram of a multifunction machine which is an example image processing apparatus equipped with a scanner function, a printer function, a facsimile function, and a network function in a combined manner. The multifunction machine 10 has a function of encrypting information, such as image data in transit among a scanner device, a printer, a facsimile, and a network device, by means of common key cryptography and a function for decrypting the information.

The multifunction machine 10 has a FAX 14 which is an example of image transmitting-receiving means; the Ethernet (Registered Trademark) 15 which is likewise an example of the image transmitting-receiving means and which establishes communication with another terminal by way of a WAN (Wide Area Network) or a LAN (Local Area Network); a scanner 16 which is an example of image reading means; an image processing circuit 17 which is an example of image processing means which is built from an ASIC (Application-Specific Integrated Circuit), or the like; a print engine 18 which is an example of printing means and which controls printing operations in electrification/exposure/development/transfer/fixing processes; an HDD (Hard Disk Drive) 19 which is an external nonvolatile storage device; an external bus 11a for interconnecting these elements; a CPU (Central Processing Unit) 11 for controls all of these elements; ROM (Read-Only Memory) 13 which stores a program executed by the CPU 11 and data required for the data; and RAM (Random Access Memory) 12 used as a work area for the CPU 11.

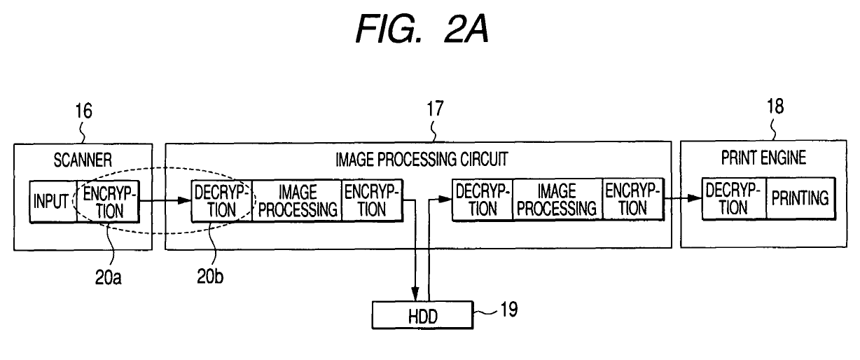

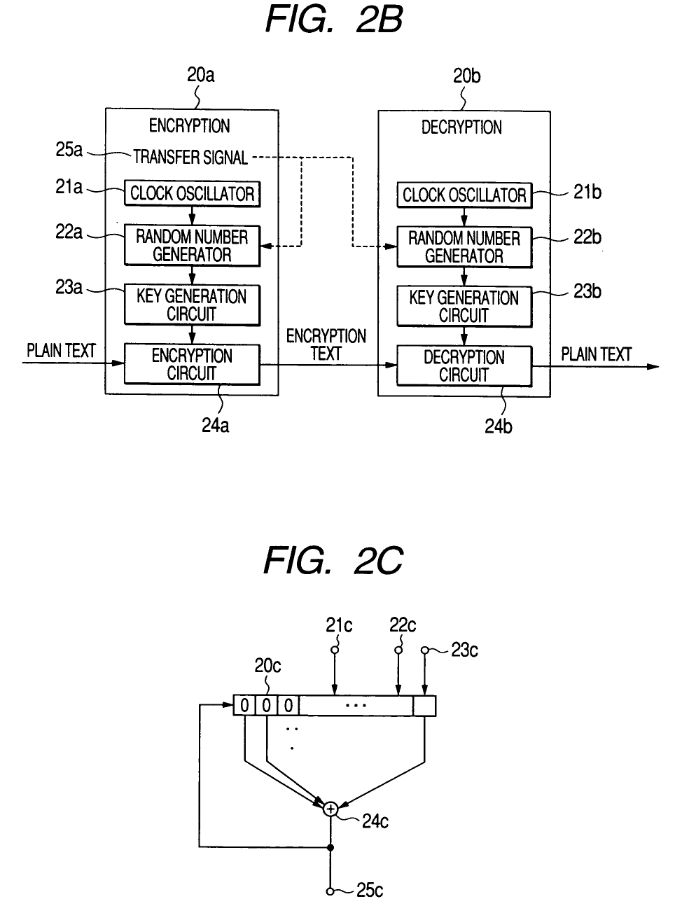

FIG. 2A is a general block diagram employed when information, such as image data, in transit among the scanner 16, the image processing circuit 17, and the print engine 18 are encrypted or decrypted. As shown in FIG. 2A, information, such as image data, encrypted by the scanner 16 is transferred to the image processing circuit 17, and the image processing circuit 17 decrypts the information. Data subjected to image processing by the image processing circuit 17 can also be encrypted and stored in the HDD 19 or transferred to the print engine 18, where the data are decrypted and printed. Information in transit among the FAX 14, the Ethernet (Registered Trademark) 15, and the image processing circuit 17, which are illustrated in FIG. 1, can also be encrypted. Although the multifunction machine is taken as an example in the present embodiment, the present invention can also be utilized for encrypting operation performed in a copier having image reading means, image processing means, and printing means; a printer having image transmitting-receiving means; a FAX; and the like.

FIG. 2B is a detailed block diagram showing in detail the configuration of encryption-decryption processing. An encryption side is provided with a transfer signal 25a which is an example of value output means; a clock oscillator 21a which is an example of synchronization means; a random number generator 22a which is an example of first value generation means; a key generation circuit 23a which is first key generation means; and an encryption circuit 24a which is an example of encryption means. In the meantime, a decryption side is provided with a clock oscillator 21b which is an example of synchronization means; a random number generator 22b which is an example of second value generation means; a key generation circuit 23b which is an example of second key generation means; and a decryption circuit 24b which is an example of decryption means.

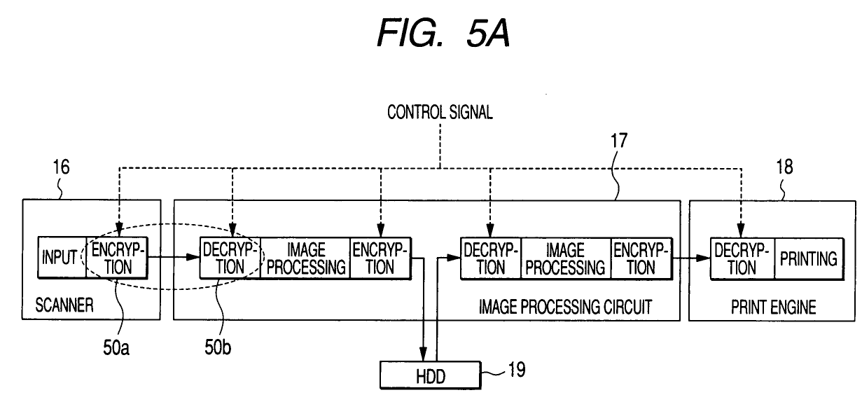

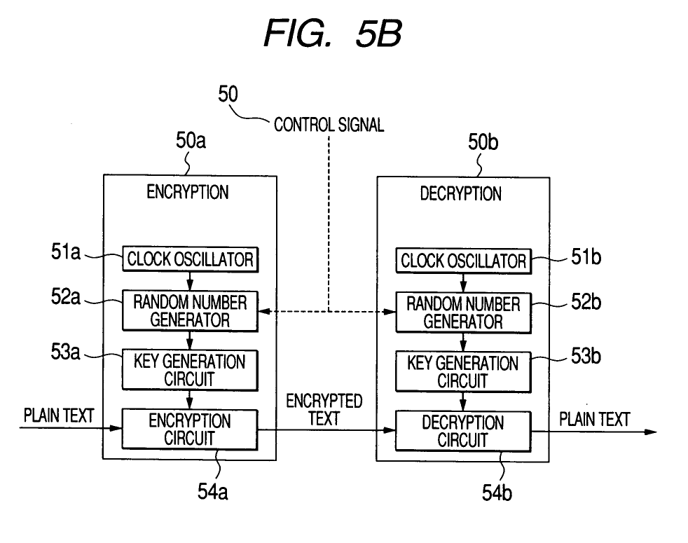

In FIG. 2A, the transfer signal 25a is a signal used when information, such as image data, is transferred from the scanner 16 to the image processing circuit 17. This signal line is connected to the random number generators 22a and 22b. The transfer signal 25a simultaneously outputs a random number from the random number generators 22a and 22b, too. The transfer signal 25a can also be output by means of transmission of pseudo data. An existing signal in the multifunction machine 10, such as a vertical synchronization signal, a horizontal synchronization signal, and the like, can also be output in place of the transfer signal. As a matter of course, a dedicated control signal line may also be provided. Further, as shown in FIGS. 5A and 5B, there may also adopted a configuration in which a control signal is output to all a random number generator provided in the scanner 16, a random number generator provided in the image processing circuit 17, and a random number generator provided in the print engine 18, to thus cause the circuits to share a single key.

The clock oscillators 21a and 21b each are built from a crystal oscillator, a ceramic oscillator, or the like, and output a clock signal of a single frequency to the random number generators 22a and 22b, to thus synchronize the random number generators.

FIG. 2C is a detailed view of the random number generators 22a and 22b. The random number generators 22a and 22b are linear feedback registers and generate a single pseudo random number in time sequence. The linear feedback register is built from a shift register 20c and an exclusive OR circuit 24c. The shift register 20c is formed from a plurality of flip-flops for holding 1-bit information and can store information of several bits to hundreds of bits, and like information. An input terminal 21c is a terminal for receiving an input of an initial value; an input terminal 22c is a terminal for receiving an input of a mode control signal; and an input terminal 23c is a terminal for receiving an input of a clock signal. An output terminal 25c is a terminal for outputting a value (random number) of the shift register 20c.

The flow of generation of a random number will be described hereunder. First, an initial value is input by way of the input terminal 21c. Next, one or two or more predetermined outputs from the shift register 20c are supplied to the exclusive OR circuit 24c. A signal output from the exclusive OR circuit 24c is input to a serial input terminal of the shift register 20c. When the mode control signal input by way of the input terminal 22c is “0” and when the clock signal is supplied from the input terminal 23c, one bit at the right end is discarded, and a 1-bit output signal from the exclusive OR circuit 24c is stored in the left end of the shift register 20c. Subsequently, updating of the value of the shift register 20c is iterated every time the clock signal is input.

For instance, consideration is given to a case where a value of 00011111 (31 in decimal number) is input as an initial value to an 8-bit shift register. When the clock signal is input, an exclusive OR product of a second bit (0) from the left, the fourth bit (1) from the left, and the sixth bit (1) from the left is computed (0). The value of 00011111 in the shift register is shifted rightward by one bit, and the thus-computed value of 0 is stored in the left end, whereupon the value of the shift register is updated to 00001111 (15 in decimal number). Further, when the clock signal is input, an exclusive OR product of the second bit (0), the fourth bit (0), and the sixth bit (1) is computed (1). The value of 00001111 in the shift register is shifted rightward by one bit, and the thus-computed value of 1 is stored in the left end. The value of the shift register is updated to 10000111 (135 in decimal number) In subsequent steps, these operations are iterated every time the clock signal is input.

In the present embodiment, a pseudo random number is taken as an example of a value which changes in time sequence. However, a value of a number sequence determined by a predetermined function, such as a physical random number utilizing thermal noise of a semiconductor element, an increment value involving a simpler configuration, and the like, may also be used. For instance, in the case of an increment value, the random number generation is equipped with a register and an adder. Every time a clock signal is input, one is added to the value of a register, to thus update the value of the register. In the case of an 8-bit register, a value is iterated, such as 0, 1, 2, . . . , 255, 0, 1, 2, . . . . Further, the random number generator may also be equipped with a logic circuit for generating a number sequence based on an arithmetic progression, a geometric progression, a recurrence formula, a nonlinear function, and the like.

The key generation circuits 23a and 23b each are built from an inverter circuit for interchanging bit values of an input random number, a shift register, and the like, and generate a key in accordance with the random numbers input by the random number generators 22a and 22b. In accordance with the key generated by the key generation circuit 23a, the encryption circuit 24a encrypts input data. A DES (Data Encryption Standard) which is known common key cryptography; a Triple DES (Triple Data Encryption Standard) which iterates encryption processing of DES three times; an IDEA (Improved Data Encryption Algorithm) which is 128-bit block cryptography, an AES (Advanced Encryption Standard) which is a next-generation encryption standard in place of the DES, and the like, can be used as the encryption algorithm.

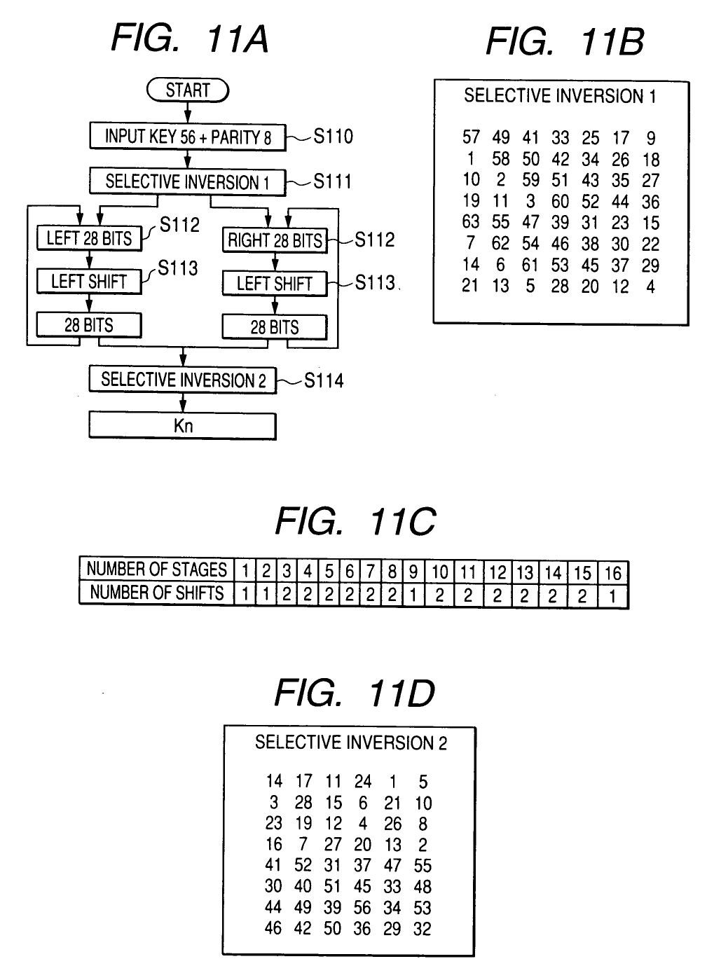

General descriptions of key generation and encryption processing will now be provided by means of taking the known DES by way of example. FIG. 11A is a flowchart of key generation performed in the key generation circuits 23a and 23b. A 64-bit random number formed by addition of eight parity bits to a 56-bit random number is input (step S110). After the eight parity bits have been removed by means of selective inversion 1, to thus interchange bits (step S111), the random number is divided into right and left blocks, each of which includes 28 bits (step S112). FIG. 11B shows a preset data sequence for selective inversion 1. This data sequence shows that the 57^{th} bit achieved before inversion comes to the first bit position after inversion. The right 28-bit block and the left 28-bit block are shifted leftward by a predetermined number of shifts for each number of processing stages (FIG. 11C) (step S113). 56 bits formed by combination of the right and left blocks are reduced to 48 bits by means of the selective inverter 2 (FIG. 11D). The bits serve as an internal key for the first stage. A 48-bit internal key is generated by means of the key generation circuit 23a and input to the encryption circuit 24a.

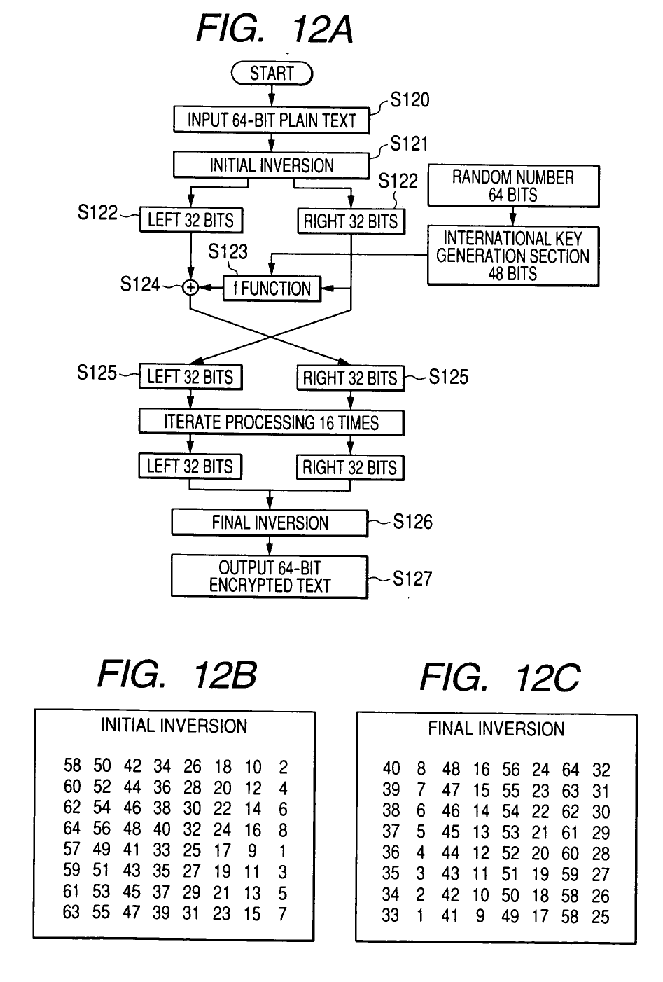

FIG. 12A shows a flowchart of encryption operation performed by the encryption circuit 24a. First, 64 bits of a plain text from the top are input (step S120). Next, the 64-bit plain text are initially inverted (FIG. 12B) (step S121), and are divided into two right and left 32-bit blocks (step S122). The previously-described 48-bit internal key and the right 32-bit block are input to a nonlinear function called an “f” function (step S123). Reference is made to a literature of Des in connection with the “f” function (step S124). The right 32 bits and the left 32 bits are interchanged (step S125), processing pertaining to the first stage is completed. Processing pertaining to steps S123 to S125 is iterated up to 16 stages. At that time, generation of an internal key utilized in step S123 is also iterated (from steps S112 to S114 in FIG. 11A). When the right 32 bits and the left 32 bits are combined together and subjected to final inversion (FIG. 12C), whereby a 64-bit encrypted text is generated (step S127). Subsequently, the next 64 bits of the plain text are input, and procedures analogous to those mentioned above are iterated.

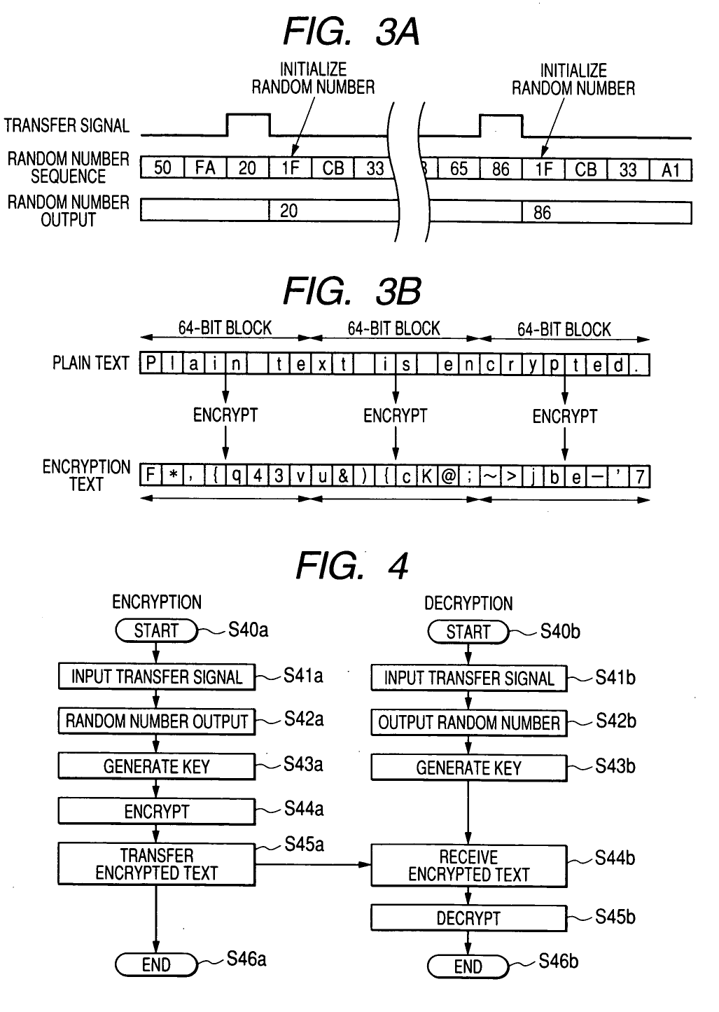

FIG. 3B shows the overview of block encryption. Although the drawing illustrates an example of encryption of text data, the same also applies to the case of image data. Text data formed from a one-byte (8 bits) character are blocked every 64 bits, and an encrypted text is output.

The decryption circuit 24b decrypts the data encrypted by the encryption circuit 24a in accordance with the key generated. The flow of decryption processing is the same as the flow of processing performed by the encryption circuit 24a.

### (Operation of the First Embodiment)

An example procedure for sharing a key will be described hereunder. FIG. 3A shows an example timing chart used for initializing a random number by utilization of a configuration described in claim 4. After simultaneously outputting random numbers from the random number generators 22a and 22b, the transfer signal initializes the random number generators 22a and 22b.

FIG. 4 is a flowchart showing an example of processing procedures of the program defined in claim 19. When transfer of information, such as image data, is initiated (S40a and S40b), a transfer signal is input to the random number generator (steps S41a and S41b), whereupon the same numbers are simultaneously output from the encryption side and the decryption side. At this time, the random number generators are initialized as mentioned previously. Keys are generated in accordance with the output random number (steps S43a and S43b) and encrypted by means of the previously-described DES algorithm (step S44a). When the encrypted text is transferred (step S45a), the text is received by the decryption side (step 45b) and then decrypted (step S45b) Next, processing is completed (steps S46a and S46b). The program is provided by communications means. However, as a matter of course, the program can also be provided while being held in a storage medium, such as CD-ROM, or the like.

### Second Embodiment

In a second embodiment, an example image processing apparatus utilizing a key sharing technique defined in claim 5 will be described.

### (Structure of the Image Processing Apparatus of the Second Embodiment)

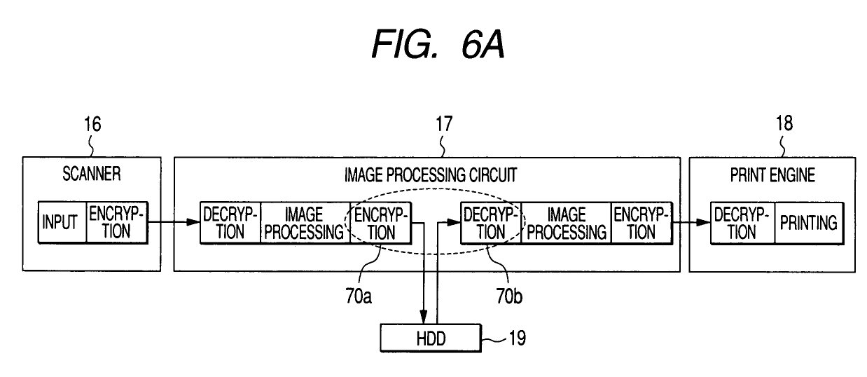

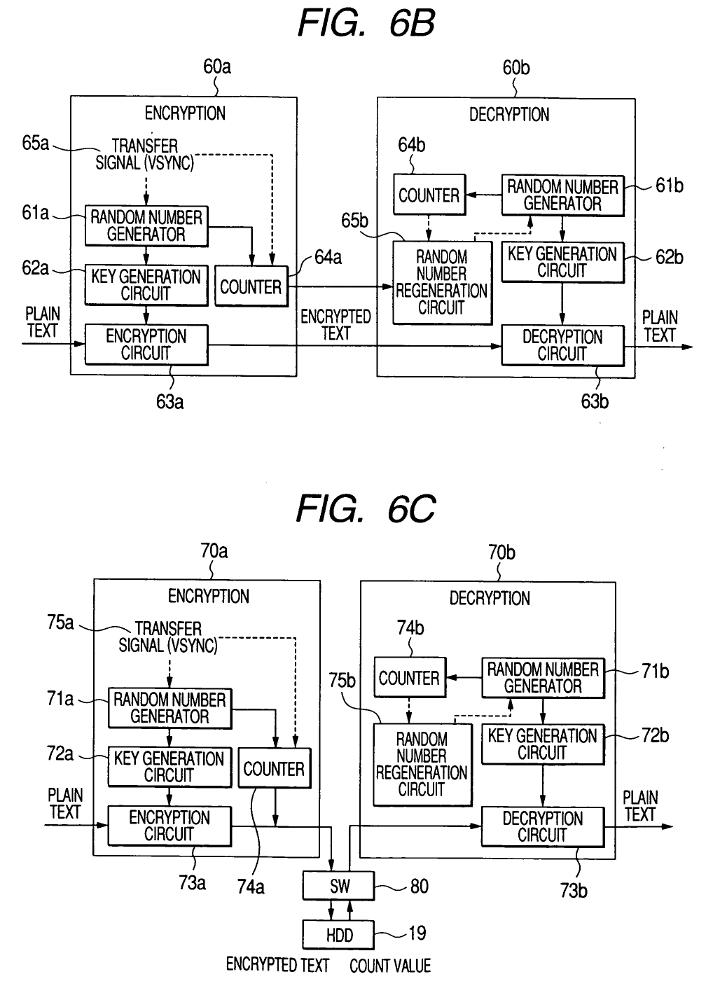

Explanations are provided by means of taking, by way of example, a multifunction machine (see FIG. 1) analogous to the first embodiment. FIG. 6B is a detailed block diagram showing the configuration of encryption/decryption processing. The encryption side is equipped with a random number generator 61a which is an example of the first value generation means; a transfer signal 65a; a counter 64a serving as an example of positional information output means; a key generation circuit 62a serving an example of first key generation means; and an encryption circuit 63a serving as an example of encryption means. In the meantime, the decryption side is equipped with a random number generator 61b serving as an example of the second value generation means; a random number regeneration circuit 65b and a counter 64b which are an example of regeneration means; a key generation circuit 62b serving as an example of second key generation means; and a decryption circuit 63b serving an example of the decryption means. Structural elements differing from those described in connection with the first embodiment will be described in detail.

The random number generators 61a and 61b generate values derived from a predetermined function, such as pseudo random number values—which are not true random numbers—or increment values. For instance, a configuration analogous to that shown in FIG. 2C can be embodied, so long as the pseudo random number values are generated.

A transfer signal 65a is used when information, such as image data, is transferred from the scanner 16 shown in FIG. 6A to the image processing circuit 17, when the information is transferred from the image processing circuit 17 to the HDD 19, and the like. A signal line for this signal is connected to the random number generator 61a and the counter 64a. The transfer signal 65a causes the random number generator 61 to output a random number, causing the counter 64a to output a count value of the random number. A horizontal synchronization signal and a vertical synchronization signal may also be utilized without utilization of this transfer signal 65a. As a matter of course, another existing signal may also be accepted, or utilization of a dedicated control signal is also practicable.

The counters 64a and 64b each are built from an adder, a register, and the like. The counters 64a and 64b count random numbers respectively generated by the random number generators 61a and 61b. For instance, when the random number generators generate a random number 1F, CB, 33, the counters output a count value 1, 2, 3. The count value is an example of positional information conforming to the time sequence of the value generated by the random number generators 61a and 61b. A time elapsed from a point in time when the random number generators are initialized can be utilized as another example of positional information conforming to the time sequence of values generated by the random number generators 61a and 61b. In this case, means for measuring and outputting time information are required.

The random number regeneration circuit 65b is built from a register, a logical AND circuit, and the like. When a count value is received from the encryption side, the random number generator 61b is initialized. A count value from the counter 64b is input and compared with a count value received by use of the logical AND circuit. When a coincidence between the received count value and the generated count value, a random number is output to the random number generator 61b. For instance, on the assumption that the received count value is three, the random number generator is caused to generate random numbers up to 1F, CB, and 33 and output the third number 33.

The other key generation circuits 62a and 62b, the encryption circuit 63a, and the decryption circuit 63b are identical in configuration with their counterpart circuits of the first embodiment (FIG. 2).

FIG. 6C shows the configuration of the storage means when encrypted data and a count value are stored in the HDD 19 serving as one example of the storage means. SW (software) 80 is an example of processing means for processing (encrypting, and the like) a count value generated by the encryption side and an example of association means for associating an encrypted text with a count value. The SW80 is stored in the ROM 13 shown in FIG. 1 and executed by the CPU 11.

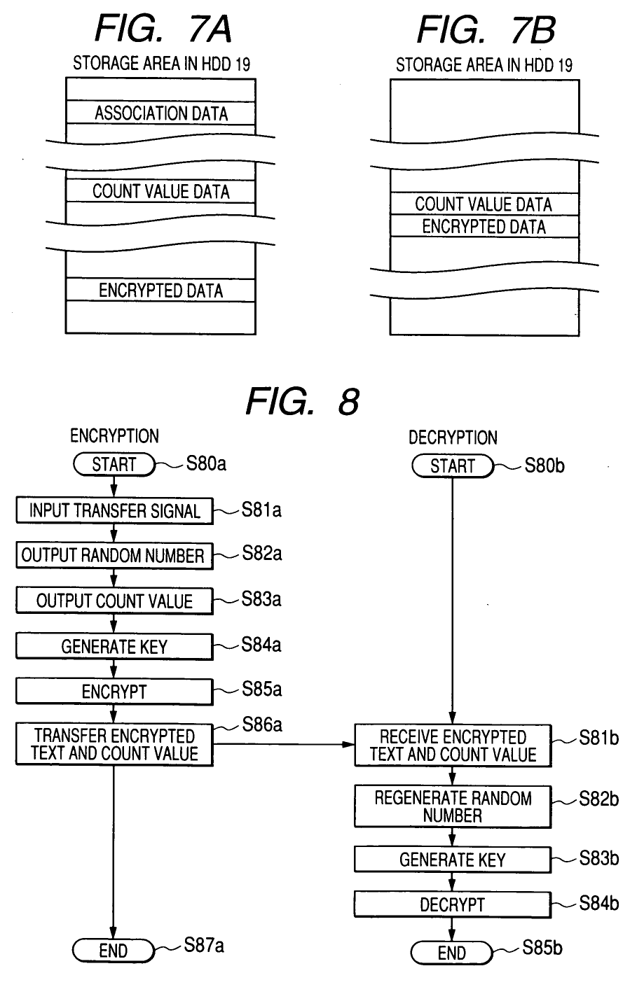

FIG. 7 is a conceptual rendering showing a storage area in the HDD 19. In FIG. 7A, encrypted data and count value data are stored in different locations in order to enhance a higher degree of safety, and the storage locations are stored as association data. In the meantime, in FIG. 7B, processed count value data and encrypted data are stored as merged (associated) data. The processed count value data are restored by means of the SW80 serving also as an example of restoration means.

### (Operation of a Second Embodiment)

An example of key-sharing procedures utilizing the count value will be described hereunder. FIG. 8 is a flowchart showing an example of procedures for use in executing a program defined in claim 20. When transfer of information (a plain text), such as image data, is commenced (S80a and S80b), a random number generator and a counter on the encryption side input a transfer signal (step S81a), whereby a random number is output from the random number generators and a count value from the counters (step S82a and S83a). In accordance with the output random number, a key is created (step S84a), and a plain text is encrypted (step S85a). When an encrypted test and the count value are transferred (step S86a), the encrypted text and the count value are received by the decryption side (step S81b), and the random number is regenerated by means of the random number regeneration circuit (step S82b), whereupon the key is generated (step S83b). The transferred encrypted text is decrypted (step S84b). Next, processing is completed (step S87a and step S85b). This program is provided by means of communications means. However, as a matter of course, the program can also be provided while remaining stored in a storage medium, such as CD-ROM.

### Third Embodiment

In a third embodiment, an example of utilization of the invention defined in claim 9 will be described.

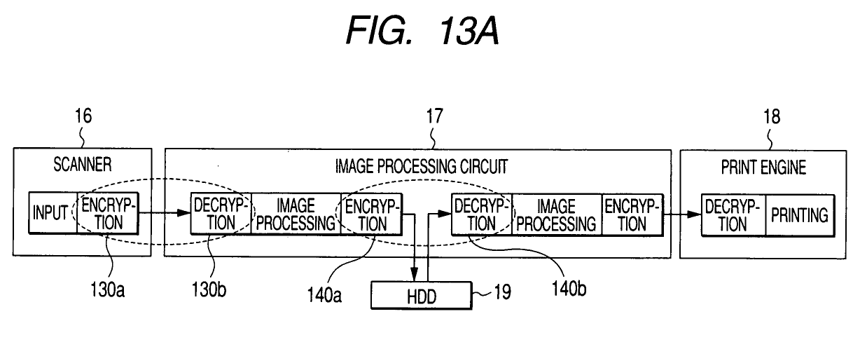

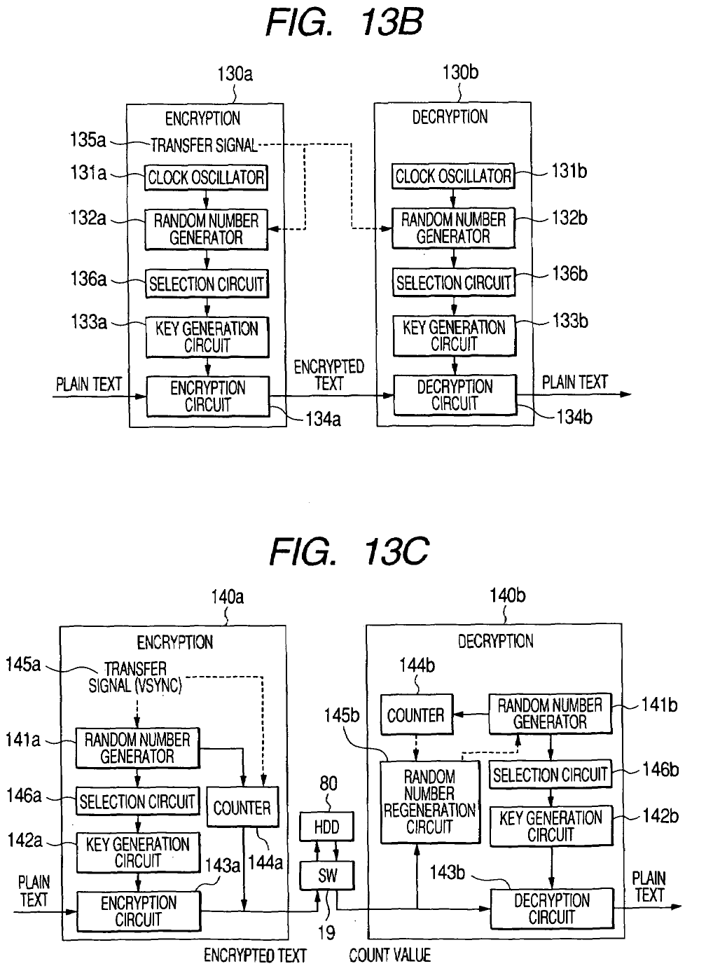

FIG. 13B shows that the encryption circuit and the decryption circuit are equipped with a selection circuit 136a serving as an example of the first selection means and a selection circuit 136b serving as an example of the second selection means. The selection circuits 136a and 136b each are built from a divider, a register, ROM, and the like. The selection circuits 136a and 136b output a selection signal for use in selecting an encryption algorithm which is an example of encryption procedures, in accordance with the random number output from random number generators 132a and 132b.

Each of an encryption circuit 134a and a decryption circuit 134b has a plurality of uniquely-developed algorithms in addition to including the previously-described known DES, Triple DES, the IDEA, and the AES. A logic circuit of an encryption algorithm is selected in accordance with a selection signal from the selection circuits 136a and 136b.

Table 1 provided below is an example table by means of which the selection circuits 136a and 136b select the previously-selected encryption algorithm. For instance, on the assumption that there are three types of selectable encryption algorithms: the DES, the IDEA, and the AES and that the random number is 100, a remainder “1” determined by dividing 100 by 3 is output as a selection signal. When the selection signal 1 is output, the encryption circuit 134a and the decryption circuit 134b encrypt/decrypt predetermined information according to the IDEA.

TABLE 1

| RANDOM NO./REMAINDER DERIVED | ENCRYPTION |
|---|---|
| FROM NUMBER OF MODES | ALGORITHM |
| 0 | DES |
| 1 | IDEA |
| 2 | AES |
| . | . |
| . | . |
| . | . |

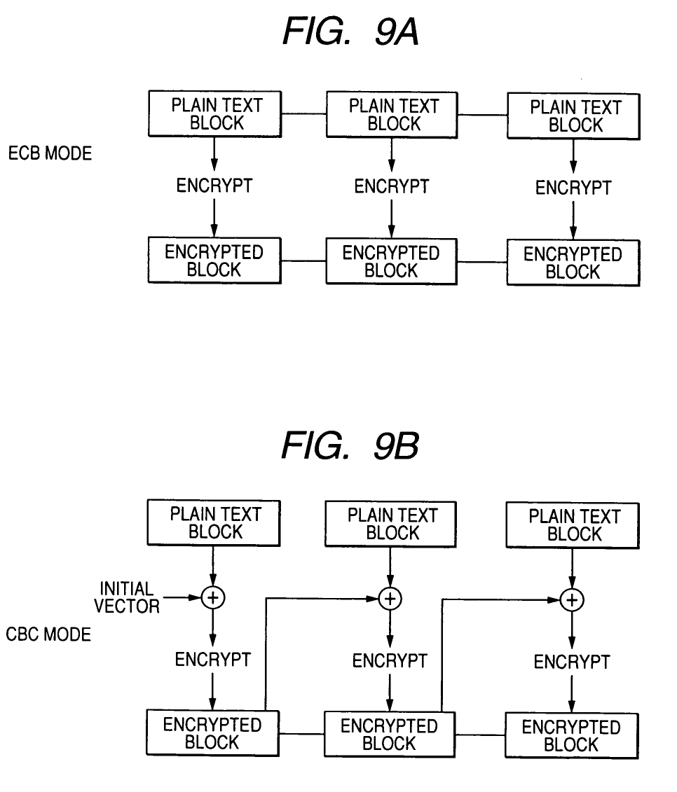

In the encryption circuit 134a and the decryption circuit 134b, the logic circuits may also be configured so as to enable processing of a plurality of block encryption modes. The block encryption mode includes a known ECB (Electronic Code Book) mode for replacing a plain text block with an encrypted block as-is, such as that shown in FIG. 9A; a CBC (Cipher Block Chaining) mode for using an encrypted block for an exclusive OR of the next plain text block, such as that shown in FIG. 9B; and the like. Table 2 provided below is an example table by means of which the selection circuits 136a and 136b select a block encryption mode in accordance with the random number output from the random number generators 132a and 132b.

TABLE 2

| RANDOM NO./REMAINDER DERIVED | ENCRYPTION |
|---|---|
| FROM NUMBER OF MODES | ALGORITHM |
| 0 | ECB |
| 1 | CBC |
| 2 | CTR |
| . | . |
| . | . |
| . | . |

In addition, the selection circuits 136a and 136b may also be configured so as to output a signal for use in selecting a key length or a block length—which is an example of an encryption unit—in accordance with the random number output from the random number generators 132a and 132b. In this case, the logic circuits must be configured in the key generation circuits 133a and 133b so as to enable generation of a plurality of key lengths. Tables 3 and 4 are mere examples by means of which the selection circuits 136a and 136b select a key length and a block length in accordance with the random numbers output by the random number generators 132a and 132b.

TABLE 3

| RANDOM NO./REMAINDER DERIVED | |
|---|---|
| FROM NUMBER OF MODES | KEY LENGTH |
| 0 | 64 |
| 1 | 128 |
| 2 | 192 |
| . | . |
| . | . |
| . | . |

TABLE 4

| RANDOM NO./REMAINDER DERIVED | |
|---|---|
| FROM NUMBER OF MODES | KEY LENGTH |
| 0 | 64 |
| 1 | 128 |
| 2 | 192 |
| . | . |
| . | . |
| . | . |

Moreover, the selection circuits 136a and 136b may also be configured so as to enable selection of encryption strength in accordance with the random number output by the random number generators 132a and 132b. Encryption strength is the degree of difficulty in estimating a plain text from an encrypted text without use of a key. Although encryption strength usually designates a key length in many occasions, the encryption strength can also be considered to be a time required to estimate a plain text from encrypted text. At that time, a predetermined computer previously measures a time required to generate keys on a round-robin system and compute a plain text by use of a predetermined encryption algorithm, a predetermined block encryption mode, a predetermined key length, and a predetermined block length, in relation to an encrypted text. Encryption strength that is a combination of the encryption algorithm, the block encryption mode, the key length, and the block length can be set according to a result of measurement. Table 5 is an example table by means of which the selection circuits 136a and 136b select encryption strength in accordance with the random numbers output by the random number generators 132a and 132b.

TABLE 5

| RANDOM NO./REMAINDER DERIVED | |
|---|---|
| FROM NUMBER OF MODES | ENCRYPTION STRENGTH |
| 0 | ECB + KEY LENGTH 64 |
| 1 | ECB + KEY LENGTH 128 |
| 2 | ECB + KEY LENGTH 192 |
| . | . |
| . | . |
| . | . |

In other respects, the circuits shown in FIG. 13B are analogous in strength to the circuits shown in FIG. 2B. Moreover, selection circuits 146a and 146b, key generation circuits 142a and 142b, an encryption circuit 143a, and a decryption circuit 143b shown in FIG. 13C are analogous to their counterpart circuits shown in FIG. 13B. In other respects, the circuits shown in FIG. 13C are analogous in structure to the circuits shown in FIG. 6C.

As mentioned above, the selection circuits can have the configuration for selecting the encryption procedures, the key length, an encryption unit, and encryption strength.

### Fourth Embodiment

In a fourth embodiment, an example encryption communications system according to claim 17 or 18 formed from the encryption communications device defined in claim 15 or 16 will be described.

### (Configuration of the System of the Fourth Embodiment)

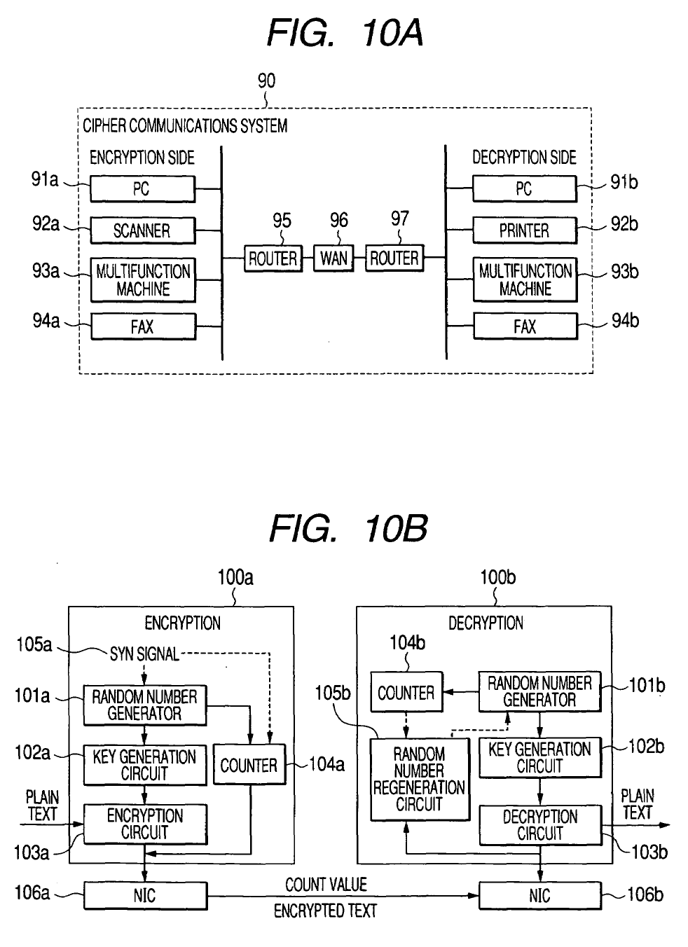

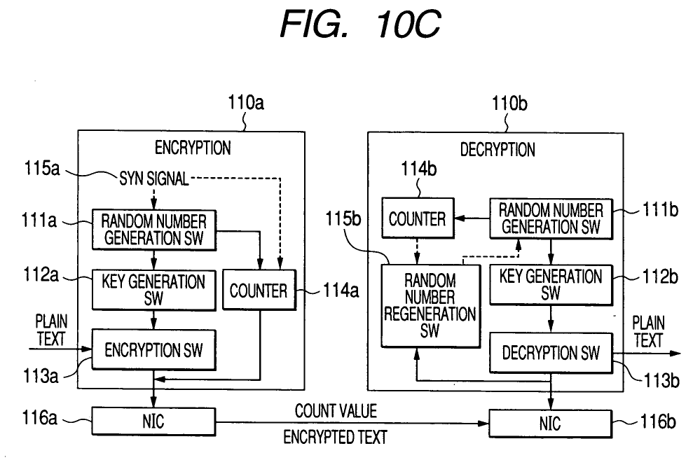

FIG. 10A is an example system block diagram of an encryption communications system 90. In this embodiment, the encryption side is equipped with devices, such as a PC 91a, a scanner 92a, a multifunction machine 93a, and a FAX 94a, which are examples of the encryption communications device defined in claim 16. Information, such as image data, encrypted in these devices is transmitted to a PC 91b, a printer 92b, a multifunction machine 93b, a FAX 94b, and the like, on the decryption side, by way of a router 95, a WAN 96, a router 97, and the like, which are examples of the encryption communications device defined in claim 16. The information is decrypted in these devices. Moreover, the communications line is not limited to the examples. Analogue communication utilizing a telephone network, digital communication utilizing an ISDN (integrated service digital network), optical communication utilizing an optical fiber network, infrared communication utilizing infrared radiation, wireless communication, such as a wireless LAN, mobile communications, satellite communication, and the like, may also be acceptable as the communications line. A radio, a mobile terminal such as a portable cellular phone and a PHS (Personal Handyphone System), may also be acceptable as the encryption-side terminal and the decryption-side terminal.

FIG. 10B is a detailed view showing the configuration of encryption processing performed respectively in the PC 91a, the scanner 92a, the multifunction machine 93a, and the FAX 94a and a detailed view showing the configuration of decryption processing performed respectively in the PC 91b, the printer 92b, the multifunction machine 93b, and the FAX 94b. Since the configurations are essentially analogous to the configuration (FIG. 6) of the second embodiment, explanations are given to a difference in configuration.

A SYN (synchronization) signal 105a is output at the time commencement of transmission performed by means of the TCP (transfer control protocol). The system is configured so as to output this SYNC signal to the random number generator 101a and the FAX 94b. Although the SYN signal is used in the present embodiment, another existing signal may also the used.

NICs (Network Interface Cards) 106a and 106b are example transmission means and example receiving means, respectively. The NICs 106a and 106b are known Ethernet (Registered Trademark) and adaptors and control transmission between adjacent nodes in the LAN. Further, a modem, a bsu (Digital Service Unit), a TA (Terminal Adaptor), a wireless LAN card, an optical communications device, a wireless device, may also be acceptable other examples of the transmission means and the receiving means.

FIG. 10C is an example in which all of the encryption and decryption processing operations are implemented by means of software which runs on a specific OS (Operating System) rather than by means of a dedicated integrated circuit.

### (Operation of the Fourth Embodiment)

When transmission of information is commenced, the SYN signal is output to the random number generator and the counter on the encryption side, whereupon the random number generator outputs a random number and the counter outputs a count value. In accordance with the output random number, the key is generated, and information is encrypted. When an encrypted text and the count value are transmitted, they are received by the decryption side; the random number regeneration circuit regenerates a random number; and a key is generated. The transmitted encrypted text is thus decrypted. This flowchart is analogous to the flowchart shown in FIG. 8. The program is provided by communications means. However, as a matter of course, the program can also be provided while being held in a storage medium, such as CD-ROM, or the like.

### Fifth Embodiment

In a fifth embodiment, an example encryption communications system defined in claim 14 built from the encryption communications apparatus defined in claim 13.

### (Configuration of the System of the Fifth Embodiment)

The system configuration of the encryption communications system of the fifth embodiment is analogous that shown in FIG. 10A. The configuration of encryption-decryption processing of each of the devices shown in FIG. 10A becomes analogous to that shown in FIG. 2B. In the configuration shown in FIG. 2B, a GPS signal from a GPS (Global Positioning System) satellite equipped with a cesium atomic clock or a rubidium atomic clock which outputs a highly-accurate clock signal can also be utilized in lieu of the transfer signal. The random number generator 22a and the random number generator 22b can be accurately synchronized to each other by means of causing the random number generators 22a and 22b to simultaneously output a random number and subsequently initializing the random number generators. The source of synchronization is not limited to the GPS satellite. Synchronization may also be realized by means of receiving an NTP (network protocol) which is a time sync protocol utilized by the Internet, a time signal of an FM (frequency modulation) radio program broadcast by NHK (Nippon Hoso Kyokai), and the like.

### (Operation of the Fifth Embodiment)

Example key sharing procedures of the fifth embodiment are analogous to those shown in FIG. 4. A “transfer signal input” in steps S41a and S41b in FIG. 4 is replaced with a step of receiving the previously-described GPS signal, the NTP, the time signal of the radio program broadcast by NHK, and the like. The program is provided by communications means. However, as a matter of course, the program can also be provided while being held in a storage medium, such as CD-ROM, or the like.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention defined by the following claims and their equivalents.

What is claimed is:

1. An image processing apparatus comprising:
a first value generation unit that generates a first value changing in time sequence;
a second value generation unit that generates a second value changing in time sequence which is identical with the first value changing in time sequence;
a synchronization unit that synchronizes the first value generation unit and the second value generation unit;
a value output unit that causes the first value generation unit and the second value generation unit to simultaneously output the first and second values;
a first key generation unit that generates a first key in accordance with the first value output by the first value generation unit;
an encryption unit that encrypts information in accordance with the first key generated by the first key generation unit;
a second key generation unit that generates a second key in accordance with the second value output by the second value generation unit; and
a decryption unit that decrypts the information encrypted by the encryption unit, in accordance with the second key generated by the second key generation unit.

2. The image processing apparatus as claimed in claim 1, wherein the value output unit causes the first value generation unit and the second value generation unit to simultaneously output the first and second values by use of a transfer signal used at the time of transfer of information.

3. The image processing apparatus as claimed in claim 1, wherein the value output unit causes the first value generation unit and the second value generation unit to simultaneously output the first and second values by use of one of a vertical synchronization signal and a horizontal synchronization signal.

4. The image processing apparatus as claimed in claim 1, wherein, in a case where the value output unit causes the first value generation unit and the second value generation unit to simultaneously output values, the value output unit concurrently initializes the first value generation unit and the second value generation unit.

5. An image processing apparatus comprising:
a first value generation unit that generates a first value changing in time sequence;
a positional information output unit that outputs time-series positional information about the first value generated by the first value generation unit;
a first key generation unit that generates a first key in accordance with the first value generated by the first value generation unit;
an encryption unit that encrypts information in accordance with the first key generated by the first key generation unit;
a second value generation unit that generates a second value changing in time sequence identical with the time sequence of the first value;
a regeneration unit that causes the second value generation unit to regenerate a first value generated by the first value generation unit in accordance with time-series positional information output by the positional information output unit;
a second key generation unit that generates a second key in accordance with a second value regenerated by the second value generation unit; and
a decryption unit that decrypts the information encrypted by the encryption unit in accordance with the second key generated by the second key generation unit.

6. The image processing apparatus as claimed in claim 5, further comprising:
a storage unit that stores information encrypted by the encryption unit and time-series positional information output by the positional information output unit; and
an association unit that associates the information encrypted by the encryption unit with a storage location of the time-series positional information output by the positional information output unit.

7. The image processing apparatus as claimed in claim 5, further comprising:
a processing unit that processes time-series positional information output by the positional information output unit;
a storage unit that stores information encrypted by the encryption unit and time-series positional information output by the positional information output unit;
an association unit that associates the information encrypted by the encryption unit with a storage location of the time-series positional information output by the positional information output unit; and
a decryption unit that decrypts the time-series positional information processed by the processing unit.

8. The image processing apparatus as claimed in claim 1, wherein the first and second values changing in time sequence are values of a random number sequence or values of a number sequence determined by a predetermined function.

9. The image processing apparatus as claimed in claim 1, further comprising:
a first selection unit that selects at least one of encryption procedures, a key length, an encryption unit and encryption strength used in accordance with the first value output by the first value generation unit; and
a second selection unit that selects at least one of encryption procedures, a key length, an encryption unit and encryption strength used in accordance with the second value output by the second value generation unit.

10. The image processing apparatus as claimed in claim 1, further comprising:
an image reading unit that optically reads an image;
an image processing unit that subjects an image read by the image reading unit to image processing; and
a printing unit that prints the image subjected to image processing by the image processing unit,
wherein
the encryption unit encrypts an image in at least one of transit between the image reading unit and the image processing unit, and between the image processing unit and the printing unit.

11. The image processing apparatus as claimed in claim 1, further comprising:
an image transmitting-receiving unit that transmits and receives an image;
an image reading unit that optically reads an image;
an image processing unit that subjects to image processing the image transmitted and received by the image transmitting-receiving unit and the image read by the image reading unit; and
a printing unit that prints the image subjected to image processing by the image processing unit,
wherein
the encryption me encrypts an image in at least one of transit between the image transmitting-receiving unit and the image processing unit, between the image reading unit and the image processing unit, and between the image processing unit and the printing unit.

12. The image processing apparatus as claimed in claim 1, further comprising:
an image transmitting-receiving unit that transmits and receives an image;
an image processing unit that subjects the image transmitted and received by the image transmitting-receiving unit to image processing; and
a printing unit that prints the image subjected to image processing by the image processing unit,
wherein
the encryption unit encrypts an image in at least one of transit between the image transmitting-receiving unit and the image processing unit, between the image reading unit and the image processing unit, and between the image processing unit and the printing unit.

13. An encryption communications apparatus that generates a value changing in time sequence, generates a key in accordance with the generated value, encrypts information in accordance with the generated key, and transmits the encrypted information, the apparatus comprising:
a receiving unit that receives the encrypted information;
a first value generation unit that generates a first value which changes, in a synchronized manner, in time sequence identical with that of the value changing in time sequence;
a first key generation unit that generates a first key in accordance with the first value generated by the first value generation unit; and
a decryption unit that decrypts the encrypted information in accordance with the first key generated by the first key generation unit.

14. An encryption communications system that generates a value which changes in time sequence, generates a key in accordance with the generated value, encrypts information in accordance with the generated key, and transmits the encrypted information, the apparatus comprising:
a receiving unit that receives the encrypted information;
a first value generation unit that generates a first value which changes, in a synchronized manner, in time sequence identical with that of the value changing in time sequence;
a first key generation unit that generates a first key in accordance with the first value generated by the first value generation unit; and
a decryption unit that decrypts the encrypted information in accordance with the first key generated by the first key generation unit.

15. An encryption communications apparatus comprising:
a first value generation unit that generates a value which changes in time sequence;
a positional information output unit that outputs time-series positional information about the value generated by the first value generation unit;
a first key generation unit that generates a first key in accordance with the first value generated by the first value generation unit;
an encryption unit that encrypts information in accordance with the first key generated by the first key generation unit; and
a transmission unit that transmits information encrypted by the encryption unit and time-series positional information output by the positional information output unit.

16. An encryption communications apparatus comprising:
a receiving unit that receives encrypted information and time-series positional information about a value which changes in time sequence;
a first value generation unit that generates a value changing in time sequence;
a generation unit that causes the first value generation unit to generate a value changing in time sequence, in accordance with time-series positional information about the value which changes in time sequence and which is received by the receiving unit;
a first key generation unit that generates a first key in accordance with the first value generated by the first value generation unit; and
a decryption unit that decrypts the encrypted information in accordance with the first key generated by the first key generation unit.

17. An encryption communications system comprising:
a first value generation unit that generates a value which changes in time sequence;
a positional information output unit that outputs time-series positional information about the value generated by the first value generation means;
a first key generation unit that generates a first key in accordance with the first value generated by the first value generation unit;
an encryption unit that encrypts information in accordance with the first key generated by the first key generation unit; and
a transmission unit that transmits information encrypted by the encryption unit and time-series positional information output by the positional information output unit,
wherein
the first value generated by the first value generation unit is regenerated in accordance with the time-series positional information transmitted by the transmission unit,
a second key is generated in accordance with the regenerated value, and
the information encrypted by the encryption unit is decrypted in accordance with the generated second key.

18. An encryption communications system that generates a value changing in time sequence, outputs the generated value and time-series positional information about the generated value, generates a key in accordance with the generated value, encrypts information in accordance with the generated key, and transmits the encrypted information and time-series positional information about the generated value, the apparatus comprising:
a receiving unit that receives the encrypted information and the time-series positional information about the generated value;
a first value generation unit that generates a first value changing in time sequence identical;
a regeneration unit that regenerates the first value generated by the first value regeneration unit in accordance with the time-series positional information about the generated value received by the receiving unit;
a first key generation unit that generates a first key in accordance with the first value regenerated by the first value generation unit; and
a decryption unit that decrypts the encrypted information in accordance with the first key generated by the first key generation unit.

19. A computer readable medium storing a program causing a computer to execute a process for preventing tapping of information, the process comprising:
generating a first value changing in time sequence;
generating a second value changing in time sequence identical with that of the first value changing in time sequence;
synchronizing the generating of the first value and the generating of the second value;
simultaneously outputting the first and second values;
generating a first key in accordance with the value output in the outputting of the first and second values;
encrypting information in accordance with the first key generated in the generating of the first key;
generating a second key in accordance with the value output in the generating of the second value; and
decrypting the information encrypted in the encrypting of the information, in accordance with the second key generated in the generating of the second key.

20. A computer readable medium storing a program causing a computer to execute a process for preventing tapping of information, the process comprising:
generating a first value changing in time sequence;
outputting the first value;
outputting time-series positional information about the first value output in the outputting of the first value;
generating a first key in accordance with the first value output in the generating of the first value;
encrypting information in accordance with the first key generated in the generating of the first key;
generating a second value changing in time sequence identical with that of the value changing in time sequence;
regenerating the first value output in the generating of the first value in accordance with the time-series positional information output in the outputting of the positional information;
generating a second key in accordance with the second value regenerated in the regenerating of the second value; and
decrypting the information encrypted in the encrypting of the information, in accordance with the second key generated in the generating of the second key.
